(19) United States
(12) Patent Application Publication
(10) Pub. No.: US 2026/0292088 A1
(43) Pub. Date: Sep. 24, 2026

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Tokyo (JP)

(72) Inventors: Risa HAYASHI, Kanagawa (JP); Yuki KANAZAWA, Kanagawa (JP); Ryosuke MASUKO, Kanagawa (JP); Natsuko KATO, Kanagawa (JP); Naoto IKEDA, Kanagawa (JP); Masanori SATAKE, Kanagawa (JP)

(73) Assignee: FUJIFILM Business Innovation Corp., Tokyo (JP)

(21) Appl. No.: 19/271,380

(22) Filed: Jul. 16, 2025

(30) Foreign Application Priority Data
Mar. 19, 2025 (JP) 2025-046052

(51) Int. Cl. H04N 1/00

(52) U.S. Cl. CPC H04N 1/00832; H04N 1/00408; H04N 2201/0094

(57) ABSTRACT

An information processing system includes a processor configured to: register an operation performed in the past and an operator in association with each other; display, as a name of the operator, contents of the operation performed in the past together with the operator; and when multiple operators registered in association with contents of a common operation are displayed together with names, display the names of the operators with the contents of the common operation abbreviated on display.

### CROSS-REFERENCE TO RELATED APPLICATIONS

This application is based on and claims priority under 35 USC 119 from Japanese Patent Application No. 2025-046052 filed Mar. 19, 2025.

### BACKGROUND

### (i) Technical Field

The present disclosure relates to an information processing system, a non-transitory computer readable medium and an information processing method.

### (ii) Related Art

Japanese Unexamined Patent Application Publication No. 2020-123235 discloses an image processing apparatus that enables setting contents of a setting history button to be recognized by displaying, on the setting history button, a difference between an initial value at the time of shipment from a factory and a setting value and a difference between an initial value set as a default value and the setting value.

A technique disclosed on an information processing system, such as a multi-function apparatus, registers an operation performed in the past in association with an operator and displays the contents of the operation performed in the past as the name of the operator.

When multiple operators registered in association with the contents of a common operation are displayed together with the names, there is a possibility that a user selects a wrong operator.

### SUMMARY

Aspects of non-limiting embodiments of the present disclosure relate to providing an information processing system, a non-transitory computer readable medium and an information processing method that control selection of a wrong operator by a user when operators registered in association with the contents of a common operation are displayed together with the names indicating the contents of operations.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: register an operation performed in the past and an operator in association with each other; display, as a name of the operator, contents of the operation performed in the past together with the operator; and when multiple operators registered in association with contents of a common operation are displayed together with names, display the names of the operators with the contents of the common operation abbreviated on display.

### BRIEF DESCRIPTION OF THE DRAWINGS

Exemplary embodiment of the present disclosure will be described in detail based on the following figures, wherein:

FIG. 1 is an external view of an image forming apparatus of an exemplary embodiment of the disclosure;

FIG. 2 is a block diagram illustrating the hardware configuration of the image forming apparatus;

FIG. 3 illustrates an example of the management table of job history information;

FIG. 4 illustrates an example of a job list display screen;

FIG. 5 illustrates an example of the job list display screen;

FIG. 6 is a flowchart illustrating the flow of an extraction process that extracts a character string indicating setting contents of each item of a job from character strings included in the name of pinned job history information;

FIG. 7 illustrates the job list display screen with names partly abbreviated;

FIG. 8 illustrates the job list display screen with names partly abbreviated;

FIG. 9 illustrates an example of the job list display screen;

FIG. 10 illustrates the job list display screen with names partly abbreviated; and

FIG. 11 illustrates the job list display screen with names partly abbreviated.

### DETAILED DESCRIPTION

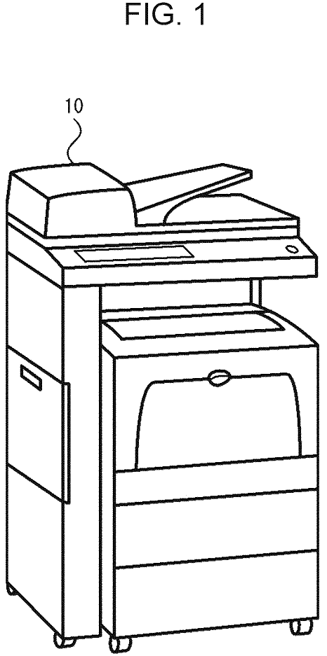

Exemplary embodiment of the disclosure is described in detail with reference to the drawings. FIG. 1 is an external view of an image forming apparatus 10 of an exemplary embodiment of the disclosure.

The image forming apparatus 10 illustrated in FIG. 1 is a multi-function apparatus having a copying function, printing function, fax function, scan functions and the like. The image forming apparatus 10 is an example of an information processing system in the technique of the exemplary embodiment of the disclosure.

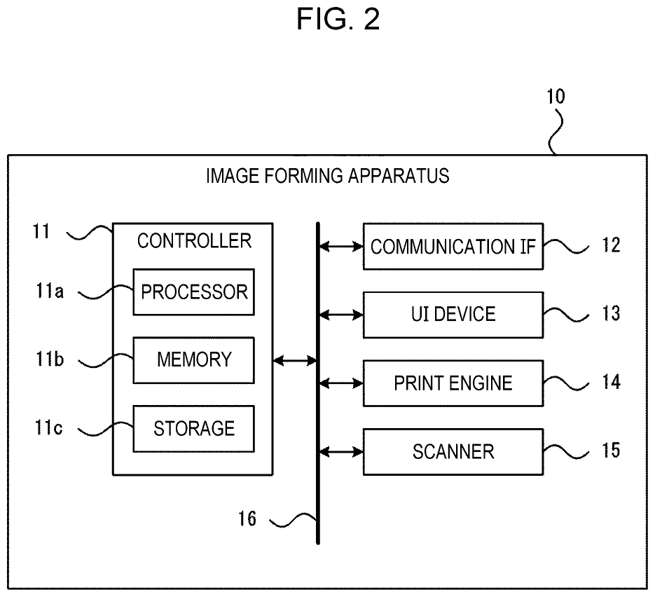

The hardware configuration of the image forming apparatus 10 of the exemplary embodiment is described. FIG. 2 is a block diagram illustrating the hardware configuration of the image forming apparatus 10.

Referring to FIG. 2, the image forming apparatus 10 includes a controller 11, communication interface (IF) 12, user interface (UI) device 13, print engine 14 and scanner 15. These elements are connected to each other via a control bus 16.

The controller 11 includes a processor 11a, memory 11b and storage 11c. The processor 11a performs a predetermined process in accordance with a program retrieved from the storage 11c and loaded onto the memory 11b. The storage 11c may be a read-only memory (ROM), hard-disk drive (HDD), solid-state drive (SSD) or the like. The storage 11c stores a variety of programs, data and the like.

According to the exemplary embodiment described above, the processor 11a retrieves the program from the storage 11c to perform the program. The disclosure is not limited to this method. The program may be supplied in a recorded form on a computer readable recording medium. The program may be retrieved from an external apparatus via a communication network.

The communication IF 12 transmits data to or receives data from an external apparatus or the like. The UI device 13 includes, for example, a touch panel and/or a button and a user receives or inputs information using the UI device 13. The print engine 14 prints an image on a recording medium, such as a paper sheet, via steps including charging, exposure, development, transfer, fixing and the like. The scanner 15 reads an original document loaded on the image forming apparatus 10 and outputs image data in a set image format.

The image forming apparatus 10 of the exemplary embodiment has a quick function that selects any job from a list indicated by job history information on history of jobs performed in the past and thus performs a new job using setting contents of a job performed in the past.

The quick function includes a pinning function that displays a specific job at the upper position of the list of the job history information.

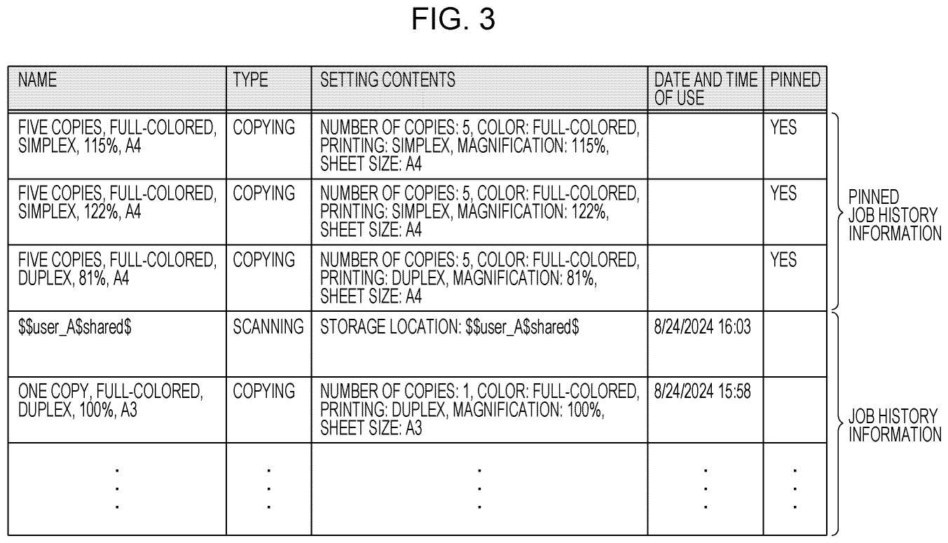

FIG. 3 illustrates an example of a management table of the job history information that is used to manage the job history information. Referring to FIG. 3, the management table of job history information manages the job history information on the jobs performed in the past.

The job history information is used to manage, on a per job basis, information on the name, type, setting contents, date and time of use, pinning and the like of each job.

The “name” herein is used to display a job on a display screen that serves to use the quick function. In the exemplary embodiment, the setting contents of a job are set as the name in the initial setting but a user may change arbitrarily the name to any name.

The “type” refers to the type of operation in a job, such as copying, faxing or scanning. The “setting contents” are related to information used when the job is performed. The “date and time of use” indicates the date and time on which the job is used. The “pinning” refers to whether the job history information is pinned in response to user operation.

When a user wants to perform a job having the same setting contents as the setting contents of a job performed in the past, the user may perform the job having the same setting contents as the setting contents in the job history information by selecting an icon indicating the contents of each list of the job history information on a job list display screen described below.

When the user performs a job using the image forming apparatus 10, new job history information is generated each time the job is performed. However, data storage area is limited and storing all the job history information may lead to insufficiency of storage area. For this reason, an upper limit is set up such that the job history information on only the latest job 200 remains and the job history information exceeding the upper limit is deleted starting with the job history information with the oldest date and time.

The job history information that the user does not want to delete may be pinned such that that job history information is not deleted. The pinned job history information is managed at a higher position in the list of the job history information and is free from being deleted even if the number of jobs performed later exceeds the upper limit.

In the pinned job history information in the management table of job history information, information on the date and time of use is deleted and information indicating the pinned job history information is recorded.

The pinned job history information remains stored regardless of the number of jobs performed later and is thus continuously displayed on an operation screen. If the job history information frequently used may be pinned and registered as the pinned job history information, the pinned job history information may be used as many times as the user like such that a job may be performed at the same setting contents.

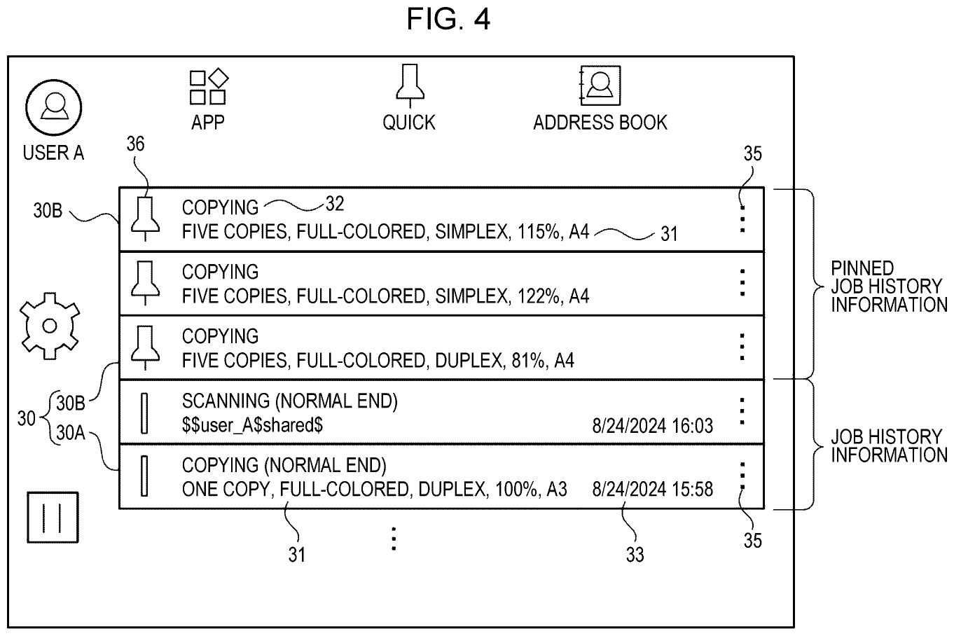

FIG. 4 illustrates an example of the job list display screen that is displayed for the user to use the quick function.

Referring to FIG. 4, the job list display screen displays a list of pieces of job history information managed in the management table of job history information. In the displayed list, each piece of the job history information is denoted by an icon 30 and the user performs a touch operation on the icon 30, thus using the job denoted by the touched icon 30. The icon 30 is an operator in the technique disclosed in the exemplary embodiment of the disclosure.

An icon 30A indicating standard job history information not pinned displays a name 31, type 32, date and time of use 33 and menu display button 35 of each job. The icon 30A indicating the standard job history information displays, at the item of the type 32 of the job, information indicating whether or not the job is normally ended.

The user may display a menu screen by touching the menu display button 35 and then may pin the job history information on the menu screen in the icon 30A indicating the standard job history information.

Although the name used with the job history information pinned is the setting contents of the job in the initial setting, the user may set any arbitrary name.

An icon 30B indicating the pinned job history information displays the name 31, type 32, menu display button 35 and pin mark 36 indicating a pinned state.

When the user touches an icon 30 on the job list display screen, the controller 11 causes the image forming apparatus 10 to shift to a job detailed setting screen of a job related to the touched icon 30. The job detailed setting screen displays the name, setting contents, start button used to perform the job, and the like of the job. The setting contents of the job may be changed on the job detailed setting screen. When the start button is touched by the user on the job detailed setting screen, the controller 11 performs the job.

The icons 30 corresponding to the job history information are deleted starting with the older icon 30 as a new job is performed. However, even when the new job is performed, the icon 30B corresponding to the pinned job history information with the pin mark 36 attached thereto remains continuously displayed at the same display location in a manner free from being affected by the new job.

When the user performs the same job as the job performed in the past, the user may perform the job in a manner free from detail setting by simply touching the icon 30 of the job being the same as or similar to a job that is going to be performed.

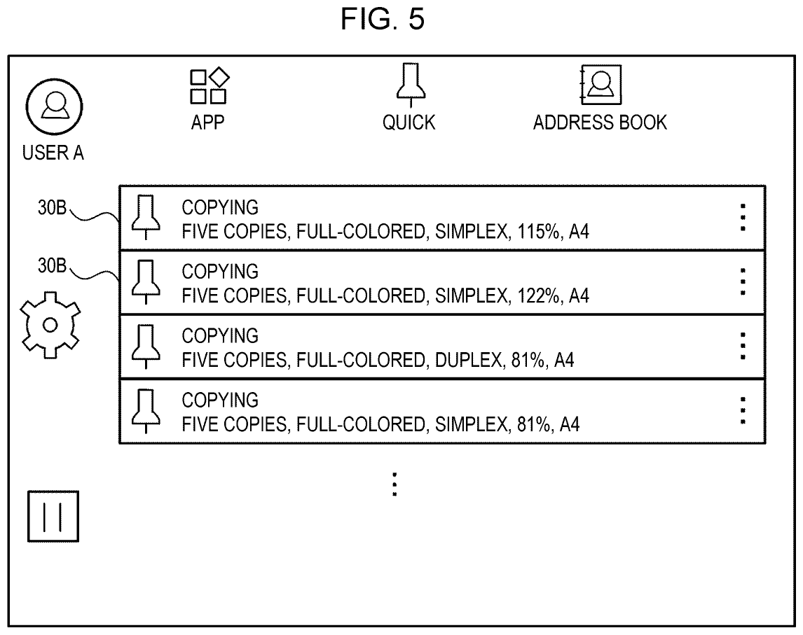

When multiple icons 30B denoting the pinned job history information having the setting contents of job serving as the names at the common type of job are displayed in the quick function as illustrated in FIG. 5, the user may select the wrong icon 30B.

In order to address the above-described problem, when multiple icons 30B indicating the pinned job history information having the common type of job with the setting contents of job serving as names are displayed, the controller 11 in the image forming apparatus 10 of the exemplary embodiment displays the names with the common setting contents abbreviated on display.

The image forming apparatus 10 of the exemplary embodiment sets the setting contents of the job as the name in the initial setting of the name of the pinned job history information. If the setting contents of the job include multiple items, the items are separated from each other with commas (,).

FIG. 5 illustrates the type of the job “copying” and four icons 30B indicating the names “five copies, full-colored, simplex, 115%, A4,” “five copies, full-colored, simplex, 122%, A4,” “five copies, full-colored, duplex, 81%, A4,” and “five copies, full-colored, simplex, 81%, A4.”

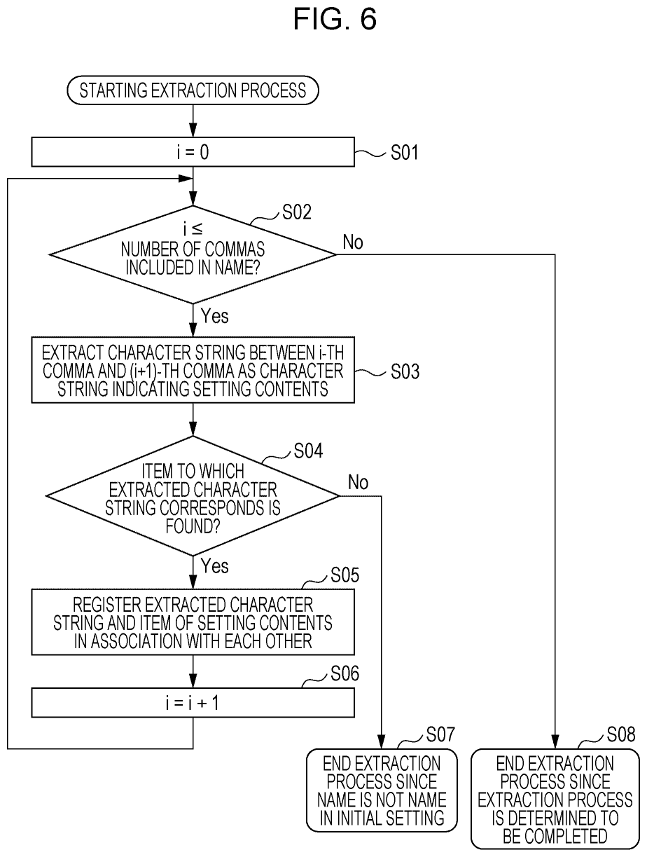

The name of the pinned job history information is set in the initial setting but, alternatively, may arbitrarily be set by the user. In the process as described below, the controller 11 may extract the character string indicating the setting contents of each item of the job from the character strings included in the names of the pinned job history information. FIG. 6 is a flowchart illustrating the flow of the extraction process that extracts the character string indicating the setting contents of each item of the jobs from the character strings included in the names of the pinned job history information.

Referring to FIG. 6, the controller 11 sets a variable i indicative of the position of a comma to zero in step S01.

The controller 11 determines in step S02 whether the variable i is equal to or below the number of commas included in the name of the pinned job history information.

If the variable i is determined to be equal to or below the number of commas included in the name of the pinned job history information in step S02, the controller 11 extracts in step S03 the character string between the i-th comma and the (i+1)-th comma as the character string indicating the setting contents.

If i=0, the i-th comma is the start position of the character string of the name. If i=the number of commas included in the name, the (i+1)-th comma is the end position of the character string of the name.

In step S04, the controller 11 checks which item of the setting contents the character string extracted in step S03 corresponds to and determines whether the corresponding item has been found.

For example, the character string “five copies” in the name corresponds to the item “number of copies” in the setting contents. The character string “full-colored” in the name corresponds to the item “color” in the setting contents. The character string “simplex” in the name corresponds to the item “print” in the setting contents.

If determining the item to which the extracted character string corresponds is found to be difficult in step S04, the controller 11 ends the extraction process in step S07 since the name of the pinned job history information is not the name in the initial setting, in other words, since the name is changed by the user.

If determining the item to which the extracted character string corresponds is found to be performed in step S04, the controller 11 registers the extracted character string and the item of the setting contents in association with each other in step S05.

The controller 11 increments the variable i in step S06 and returns to step S02.

If the variable i is determined to be above the number of commas included in the name of the pinned job history information in step S02, namely, if the extraction process for all the character strings separated by commas in the name is complete, the controller 11 ends the extraction process in step S08.

The controller 11 identifies the setting contents of the item to which one or more character strings separated by commas in the name in the icon 30B indicating a single piece of pinned job history information corresponds. The same process described above is performed on the icons 30B indicating all the pinned job history information. In other words, the same process is performed on the icons 30B corresponding to all the pinned job history information recorded on the management table of job history information. In this way, the controller 11 identifies a common setting content in the names of the icons 30B displayed on the job list display screen.

In the exemplary embodiment, the controller 11 may abbreviate on display the common setting contents in the names of all the registered icons 30B in display.

For example, as illustrated in FIG. 5, the common setting contents “five copies, full-colored, A4” may be abbreviated on display in the names of the four icons 30B having the type of job “copying.”

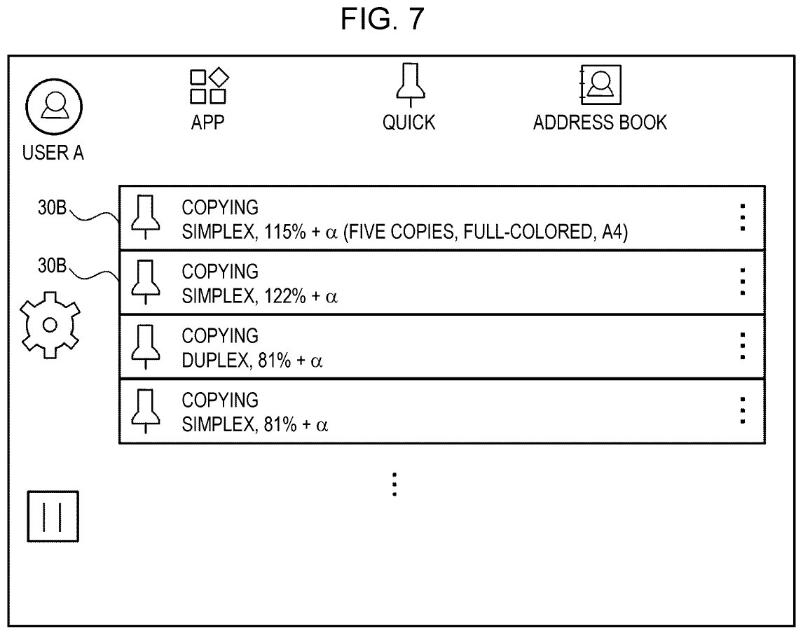

Specifically, as illustrated in FIG. 7, the common setting contents “five copies, full-colored, A4” are abbreviated as “+α” on display. In this case, the omitted contents are displayed in parentheses next to “+α” at the top of the list.

The setting contents displayed in the names of the four icons 30B having the type of job “copying” are only two setting contents “print” and “magnification.”

In comparison with the case in which all five setting contents “number of copies,” “color,” “print,” “magnification” and “sheet size” are displayed, the number of display items is smaller and identifying each icon 30B may be easier.

The controller 11 may abbreviate on display the common setting contents in the names of a set percentage or more of all the registered icons 30B. In such a case, the controller 11 may set the percentage in response to an instruction input by the user.

For example, the percentage may be set to be 60%. Referring to FIG. 5, the common setting contents in the names of 60% or more of the icons 30B “five copies, full-colored, simplex, A4” are abbreviated in the names of the four icons 30B having the type of job “copying” on display.

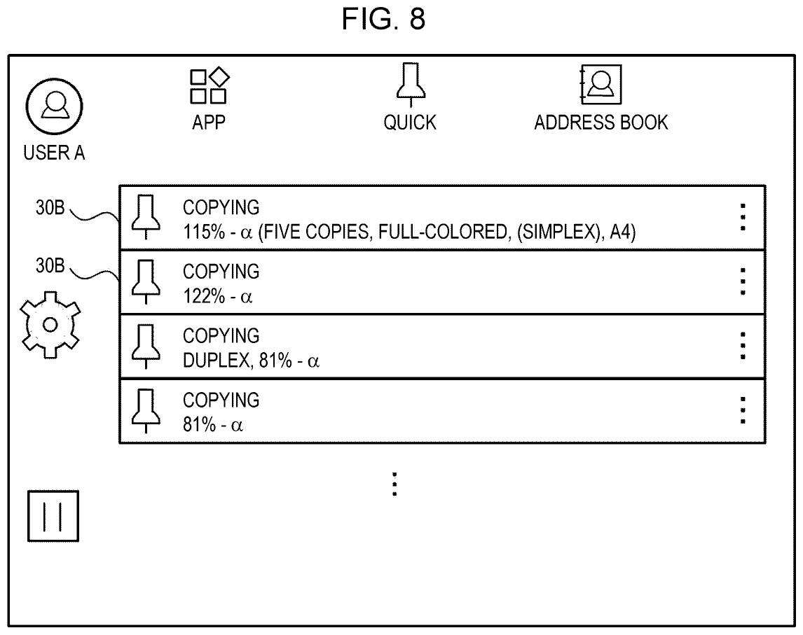

Specifically, as illustrated in FIG. 8, the common setting contents “five copies, full-colored, simplex, A4” in the names of 60% or more of the icons 30B are abbreviated as “−α” on display. In this case, the omitted contents are displayed in parentheses horizontally next to only “−α” at the top.

“Simplex” that is the setting contents not common to all of 60% of the icons 30B is displayed in parentheses to indicate that “simplex” is not common to all the names of the icons 30B.

The icon 30B with the setting item “print” not being “simplex” (see the third icon 30B from the top in the example illustrated in FIG. 8) displays “duplex” as a different setting content in the name of the icon 30B.

In comparison with the case in which the five setting contents “number of copies,” “color,” “print,” “magnification,” and “sheet size” are all displayed, the display items are smaller in number and identifying each icon 30B may be easier.

The controller 11 may divide multiple registered icons 30B into groups and may display the names of multiple icons 30B on a per group basis with the common setting contents abbreviated in the names on display.

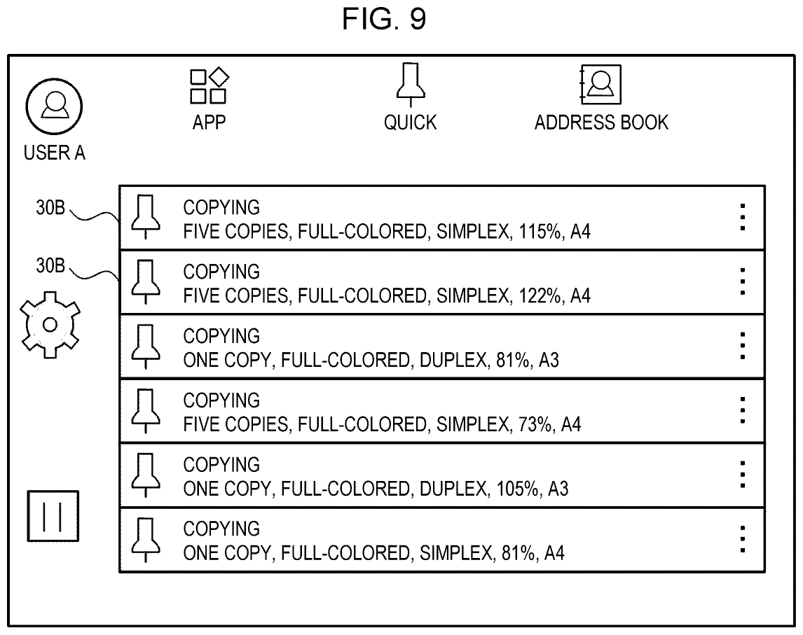

FIG. 9 illustrates six icons 30B respectively denoting, under the type of job “copying,” names “five copies, full-colored, simplex, 115%, A4,” “five copies, full-colored, simplex, 122%, A4,” “one copy, full-colored, duplex, 81%, A3,” “five copies, full-colored, simplex, 73%, A4,” “one copy, full-colored, duplex, 105%, A3,” and “one copy, full-colored, simplex, 81%, A3.”

Referring to FIG. 9, the setting contents “five copies, full-colored, A4” are common to the first icon 30B, second icon 30B and fourth icon 30B from the top. The setting contents “one copy, full-colored, A3” are common to the third icon 30B, fifth icon 30B and sixth icon 30B from the top. In this way, the icons 30B having the common setting contents are divided into the same groups in this way.

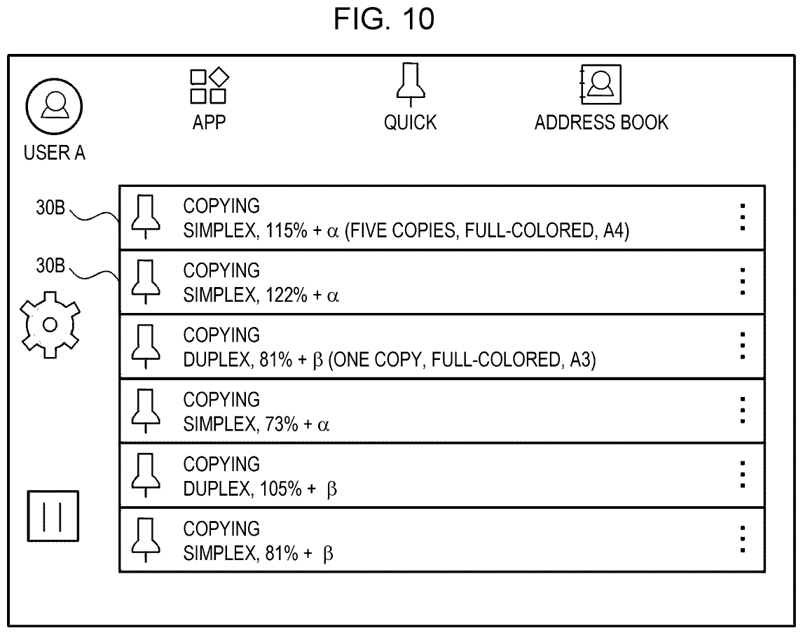

In an abbreviation method of the name of the icon 30B, “five copies, full-colored, A4” serving as the common setting contents at the first group are abbreviated as “+α” on display as illustrated in FIG. 10. In this case, only “+α” displayed at the top is horizontally followed by the omitted contents in parentheses. The common setting contents “one copy, full-colored, A3” at the second group are abbreviated as “+β” on display. In this case, only “+β” displayed at the top of the group is horizontally followed by the omitted contents in parentheses.

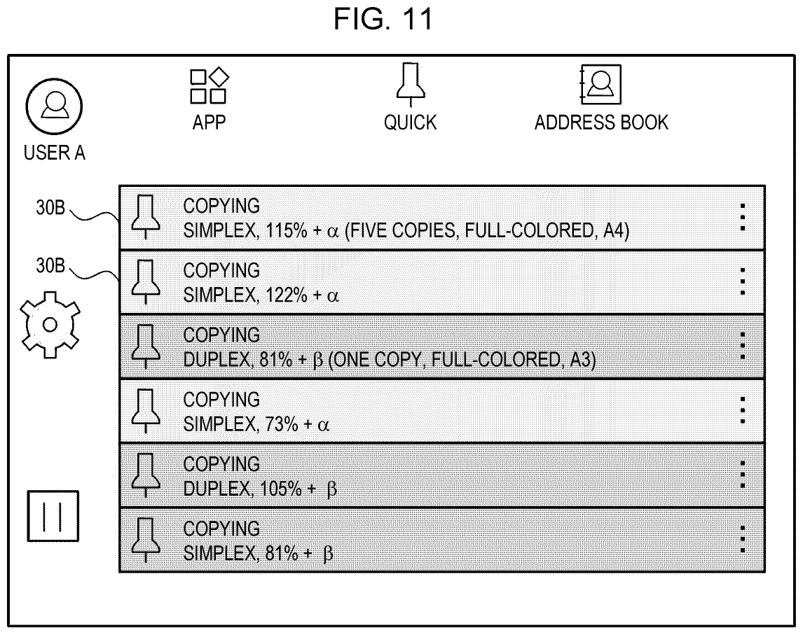

Referring to FIG. 11, the background color of the icons 30B may be set to be different depending on group in order to increase visibility of the icons 30B in the same group.

The group division method of the icons 30B is not limited to the above-described method in which the icons 30B having the same setting contents are divided in the same group, and the controller 11 may divide the icon 30B into groups in response to an instruction from the user.

### Modifications

The information processing system of the exemplary embodiment of the disclosure has been described and the technique of the disclosure is not limited to the embodiment and may be appropriately modified.

The abbreviation method of the names of the icons 30B is not limited to the above-described method and for example, any abbreviation method on display may be used instead of using “+α” or “+β”. For example, abbreviation may be indicated by using a character string, mark or the like.

In an aspect of the exemplary embodiment, the common setting contents are abbreviated on display in the names of the icons 30B indicating the pinned job history information having the common type of job. The disclosure is not limited to the aspect, and in another aspect, the display of the common setting contents may be abbreviated on display in the names of the icons 30A indicating the standard job history information and the icons 30B indicating the pinned job history information, having the common type of job.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The “system” in the exemplary embodiment may be configured to include a single apparatus or multiple apparatuses.

The disclosure may be applicable to a program or a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system including:
a processor configured to:
   register an operation performed in the past and an operator in association with each other;
   display, as a name of the operator, contents of the operation performed in the past together with the operator; and
   when multiple operators registered in association with contents of a common operation are displayed together with names, display the names of the operators with the contents of the common operation abbreviated on display.
(((2)))

In the information processing system according to (((1))), the processor is configured to abbreviate on display the contents of the common operation in the names of the registered operators.
(((3)))

In the information processing system according to (((1))), the processor is configured to abbreviate on display the contents of the common operation in the names of a set percentage or more of the registered operators.
(((4)))

In the information processing system according to (((3))), the processor is configured to set the percentage in accordance with an instruction input by a user.
(((5)))

In the information processing system according to one of (((1))) through (((4))), the processor is configured to:
divide the registered operators into groups; and
abbreviate on display the contents of the common operation in the names of the operators on a per group basis.
(((6)))

In the information processing system according to (((5))), the processor is configured to set, to be into an identical group, operators having the registered contents of an identical operation.
(((7)))

In the information processing system according to (((5))), the processor is configured to set the groups in accordance with an instruction input by a user.
(((8)))

A program causing a computer to execute a process comprising:
registering an operation performed in the past and an operator in association with each other;
displaying, as a name of the operator, contents of the operation performed in the past together with the operator; and
when multiple operators registered in association with contents of a common operation are displayed together with names, displaying the names of the operators with the contents of the common operation abbreviated on display.

What is claimed is:

1. An information processing system comprising:
a processor configured to:
register an operation performed in the past and an operator in association with each other;
display, as a name of the operator, contents of the operation performed in the past together with the operator; and
when a plurality of operators registered in association with contents of a common operation are displayed together with names, display the names of the operators with the contents of the common operation abbreviated on display.

2. The information processing system according to claim 1, wherein the processor is configured to abbreviate on display the contents of the common operation in the names of the registered operators.

3. The information processing system according to claim 1, wherein the processor is configured to abbreviate on display the contents of the common operation in the names of a set percentage or more of the registered operators.

4. The information processing system according to claim 3, wherein the processor is configured to set the percentage in accordance with an instruction input by a user.

5. The information processing system according to claim 1, wherein the processor is configured to:
divide the registered operators into groups; and
abbreviate on display the contents of the common operation in the names of the operators on a per group basis.

6. The information processing system according to claim 5, wherein the processor is configured to set, to be into an identical group, operators having the registered contents of an identical operation.

7. The information processing system according to claim 5, wherein the processor is configured to set the groups in accordance with an instruction input by a user.

8. A non-transitory computer readable medium storing a program causing a computer to execute a process comprising:
registering an operation performed in the past and an operator in association with each other;
displaying, as a name of the operator, contents of the operation performed in the past together with the operator; and
when a plurality of operators registered in association with contents of a common operation are displayed together with names, displaying the names of the operators with the contents of the common operation abbreviated on display.

9. An information processing method comprising:
registering an operation performed in the past and an operator in association with each other;
displaying, as a name of the operator, contents of the operation performed in the past together with the operator; and
when a plurality of operators registered in association with contents of a common operation are displayed together with names, displaying the names of the operators with the contents of the common operation abbreviated on display.
